(19) United States
(12) Patent Application Publication
(10) Pub. No.: US 2005/0078086 A1
(43) Pub. Date: Apr. 14, 2005

(54) Method and apparatus for controlled display

(76) Inventors: Richard E. Grams, Chandler, AZ (US); Ryan M. Brinkerhoff, Mesa, AZ (US); John E. Clayton, Scottsdale, AZ (US); Melissa C. Thornton, Chandler, AZ (US)

Correspondence Address: AKERMAN SENTERFITT, P.O. BOX 3188, WEST PALM BEACH, FL, 33402-3188, US

(21) Appl. No.: 10/682,767

(22) Filed: Oct. 9, 2003

(51) Int. Cl. G09G 5/00; G09G 5/08; G06F 3/00; G06F 17/00; G06F 9/00

(52) U.S. Cl. 345/158

(57) ABSTRACT

An electronic controller apparatus (30) having an input device (36) coupled to a display (34) can include a motion detector (40) and a means (42, 44, 46, 48, and 50) for maintaining the display in a predetermined orientation relative to a user of the electronic device and regardless of the movement of the input device. The movement of the input device causes a signal to vary in the electronic controller apparatus. The electronic controller can be a hand held device such as a game controller, a personal digital assistant, a cellular phone, a remote control device, or a gaming adaptor for a personal digital assistant or for a cellular phone. The means for maintaining the display in the predetermined orientation can use gravity to maintain the predetermined orientation or alternatively use electronic sensors (104 and 105) and motors (108 and 110) to maintain the predetermined orientation of the display.

### CROSS-REFERENCE TO RELATED APPLICATIONS

Not applicable

### FIELD OF THE INVENTION

This invention relates generally to display orientation, and more particularly to a method and system for controlling a display orientation while using an input function.

### BACKGROUND OF THE INVENTION

Up until now, hand held gaming units were held steady with their displays oriented directly at the user. Traditionally, hand held gaming units have had their buttons as the primary user input. However, tilt has now become a new gaming control input with the proliferation of MEMS accelerometer technology. Tilt input is now possible with both side to side tilting and front to back tilting. When using the tilt input or function with such devices, a major problem or disadvantage is that the display is no longer oriented directly at the user as the tilt function is used. This creates non-optimal viewing angles for at least two reasons. First, with liquid crystal display (LCD) technology the crispness of the display is reduced when viewed at an angle. Second, and perhaps more important, is an annoying glare that is created off of the glass surface of the display. The glare is particularly bad when used inside with overhead lighting with multiple light sources, but this new phenomenon is also bad in many single light source environments. While tilting is good for controlling many different types of games, the corresponding display movement is not.

In U.S. Pat. No. 6,375,572 by Masuyama et. al, and assigned to Nintendo Co., Ltd, a hand-held game device receives a cartridge having an XY-axes acceleration sensor and a Z-axis contact switch. Thus, this 3 axis arrangement can allow motions in the up and down direction to act as a gaming input. So, for instance, the user could fly a plane by tilting in four (4) directions (left, right, climb, and dive) and use a sudden downward movement to provide an additional input that could be used to drop a bomb in the case of a flight simulator game. Once again, all these previously described movements will correspondingly move a display in a fashion that is sub-optimal for viewing.

### SUMMARY OF THE INVENTION

A method, system and apparatus for providing a controlled display orientation is shown. Although the embodiments discussed herein primarily concern hand held gaming controls, the concepts herein are applicable to a wide variety of devices having displays. Thus, embodiments disclosed enable a display on a device such a hand held gaming control to maintain a controlled orientation for the display. For example, the display on the hand held gaming control can be maintained in an orientation pointed at the user while they are using tilt as a gaming input. In the simplest form for example, the hand held gaming control can use gravity to keep the display pointed directly at the user. In a more complex form, motion detectors such as MEMS accelerometers could be used to detect the tilt of the display itself which would drive small electric motors to keep the display at an optimal viewing angle.

In a first aspect of the present invention, a method of orienting a display relative to an input device can include the steps of affixing the input device to the display in at least a first orientation and enabling the input device to move on an axis in at least a second orientation relative to the display which substantially maintains the first orientation. The input device can optionally move in other orientations while substantially maintaining the display in the first orientation.

In a second aspect of the present invention, an electronic controller apparatus having an input device coupled to a display can include a motion detector within the input device and a means for maintaining the display in a predetermined orientation relative to a user of the electronic device and regardless of the movement of the input device. The movement of the input device causes a signal to vary in the electronic controller apparatus. The electronic controller can be a hand held device selected from the group comprising a game controller, a personal digital assistant, a cellular phone, a gaming adaptor for a personal digital assistant, a gaming adaptor for a cellular phone, and a remote control device. Furthermore, the means for maintaining the display in the predetermined orientation can use gravity to maintain the predetermined orientation or alternatively use electronic sensors and motors to maintain the predetermined orientation of the display.

In a third aspect of the present invention, an electronic controller having an input device can include a display pivotably coupled to the input device enabling relative movement in at least a first axis while maintaining the display in a first orientation and a tilt sensor within the input device. The display can remain in the first orientation for example by using gravity or by using electronic sensors and motors associated with the display. The electronic apparatus can further include a position adjustment device for fine tuning an orientation of the display using a means for changing a center of gravity such as a shiftable weight or a moving pivot.

### BRIEF DESCRIPTION OF THE DRAWINGS

FIG. 1 illustrates an existing game controller having a tilt function.

FIG. 2 illustrates an existing hand-held gaming device with a color display that further includes that capability of using a tilt function.

FIG. 3 is a front view of a hand-held game adaptor device constructed in accordance with an embodiment of the present invention.

FIG. 4 is a front view of another hand-held game adaptor device constructed in accordance with an embodiment of the present invention.

FIG. 5 is a front view of yet another device using the adaptor device of FIG. 4.

FIG. 6 is a block diagram of an apparatus for orienting a display in accordance with an embodiment of the present invention.

FIG. 7 is a flow chart illustrating a method of controlling a display orientation in accordance with an embodiment of the present invention.

### DETAILED DESCRIPTION OF THE DRAWINGS

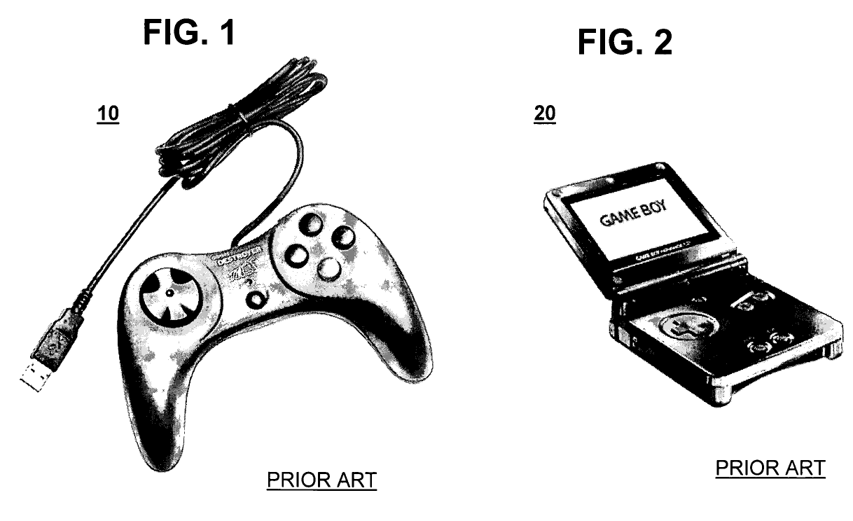

Referring to FIG. 1, an existing game controller 10 is shown that uses atilting function as an input. In this instance, the game controller or handheld device does not include a display and thus fails to present the problems previously described above. On the other hand, several hand-held gaming devices such as the well known Gameboy Advance hand-held gaming device 20 as shown in FIG. 2 can include a display and a tilting function. In one known game called Kirby's Tilt 'n Tumble 2, in order to move Kirby around, the device 20 is tilted in the desired direction. To make Kirbyjump, the gaming device 20 is jolted or suddenly moved up and down. But as previously explained, the user experience is typically unsatisfactory because it is difficult to see what is going on in the screen or display as the device is tilted.

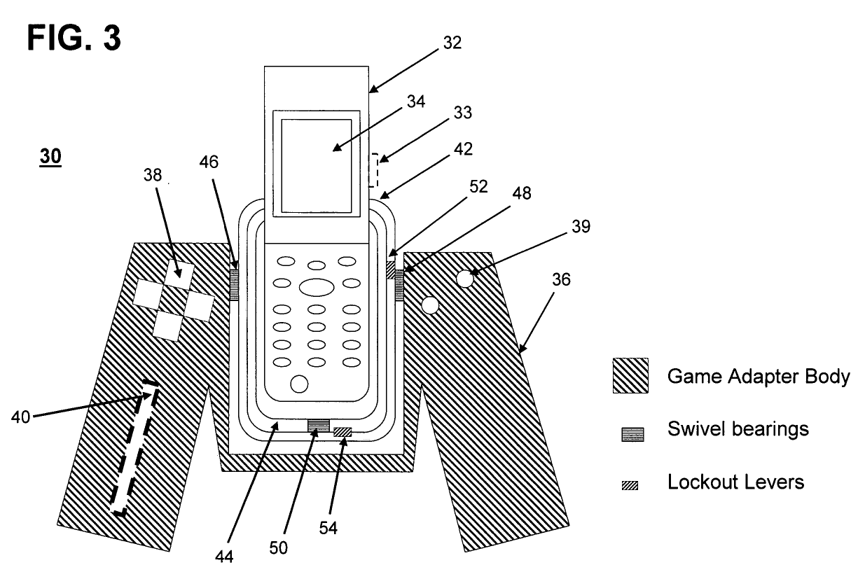

Referring to FIG. 3, a game adaptor device or electronic controller apparatus 30 is shown having an input device 36 coupled to a display 34. The display 34 can be a part of any handheld electronic device 32 such as a hand-held gaming device, a remote control, a personal digital assistant or a cellular phone for example. The electronic device can also be a gaming adaptor for a personal digital assistant or a cellular phone or any other device having a display. The input device 36 can include various inputs such as keypads 38 and 39 as well as motion sensor 40. The motion sensor 40 can be a tilt sensor, an accelerometer or other motion sensing device that causes a signal to vary in the electronic controller apparatus 30 when the input device 36 is moved. Furthermore, the direction of the motion detected can be for a single axis or for any number of axes.

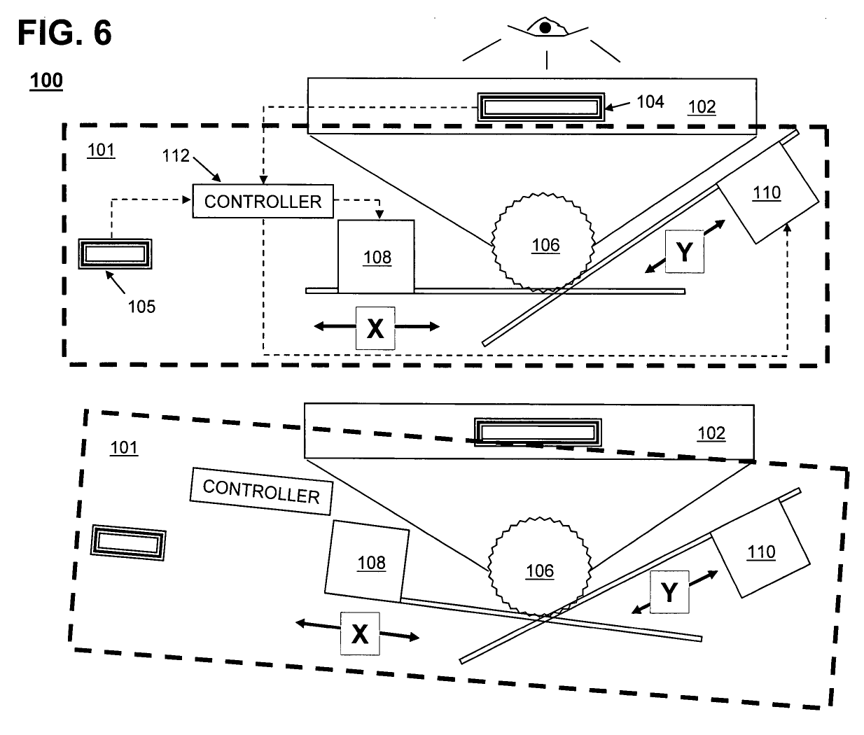

The electronic controller apparatus 30 can also include a means for maintaining the display in a predetermined orientation relative to a user of the electronic device and regardless of the movement of the input device. The means for maintaining the display in the predetermined orientation can include the use of gravity to maintain the predetermined orientation as shown in the embodiments of FIGS. 3-5 or alternatively can include the use of electronic sensors and motors to maintain the predetermined orientation as shown in FIG. 6. In a gravity based solution as shown in FIG. 3, the handheld electronic device 32 can be set in a cradle or bracket 44 that moves relative to another bracket 42. The bracket 42, in turn can move relative to the input device 36. In this arrangement, the bracket 44 is coupled to the bracket 42 and moves relative to the bracket 42 using a swivel bearing 50. Likewise, the bracket 42 moves relative to the input device 36 using swivel bearings 46 and 48.

The relative motion between brackets 42,44 and between the bracket 42 and the input device can be fixed or locked using lockout levers. A lockout feature could be included to disable the swivel motion on one or more axes. For example, a lockout lever 54 can lock the swivel bearing 50 such that only relative up and down (dive and climb) movement of the input device 36 is possible when the swivel bearings 46 and 48 are unlocked. In other words, left and right (or counter-clockwise and clockwise) movement of the input device 36 will cause the display 34 to move left and right respectively when swivel bearing 50 is locked. In another example, a lockout lever 52 can lock the swivel bearing 48 (and effectively 46) such that only relative left and right movement of the input device 36 is possible when the swivel bearing 50 is unlocked. If all swivel bearings are left unlocked, then the input device 36 and the display 34 can move relative to each other left and right as well as up and down. Assuming that the swivel bearings are properly lubricated and the electronic apparatus is appropriately balanced, the display should remain in a first orientation relative to the left/right movement or the up/down movement of the input device 36. For appropriate balance, the electronic apparatus 32 or the electronic controller device 30 can further include a position adjustment device 33 for fine tuning an orientation of the display using a shiftable weight or a moving pivot in order to change the center of gravity of the electronic apparatus 32. Also note that the lockout levers can be used to dampen relative motion of the electronic apparatus 32 in one orientation or another instead of completely locking out such movement. Thus, the electronic controller apparatus 30 can include a damping adjustment as described or in some other form to reduce excessive “swinging” of the display in very active games for example. In any event, a position adjustment could be included to allow for fine tuning of the display orientation. For an electrical solution, this can be an adjustment knob.

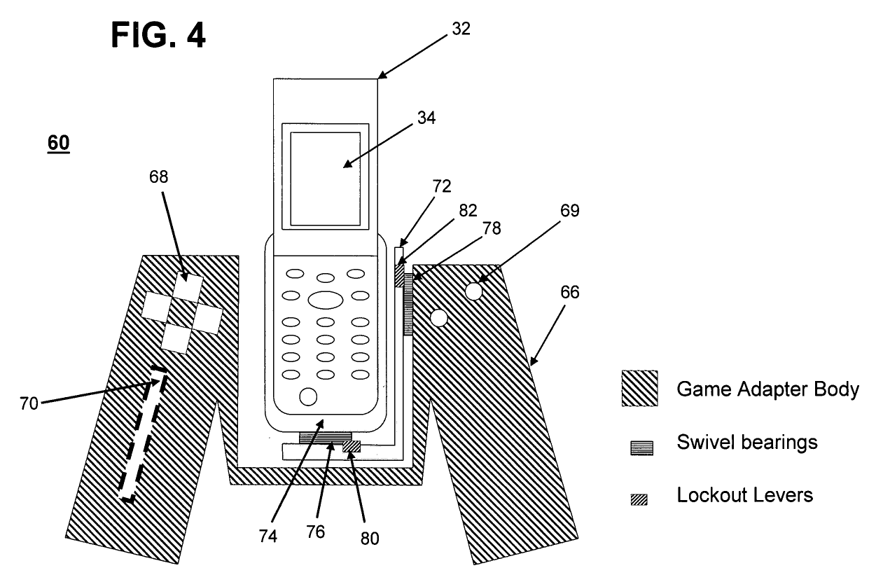

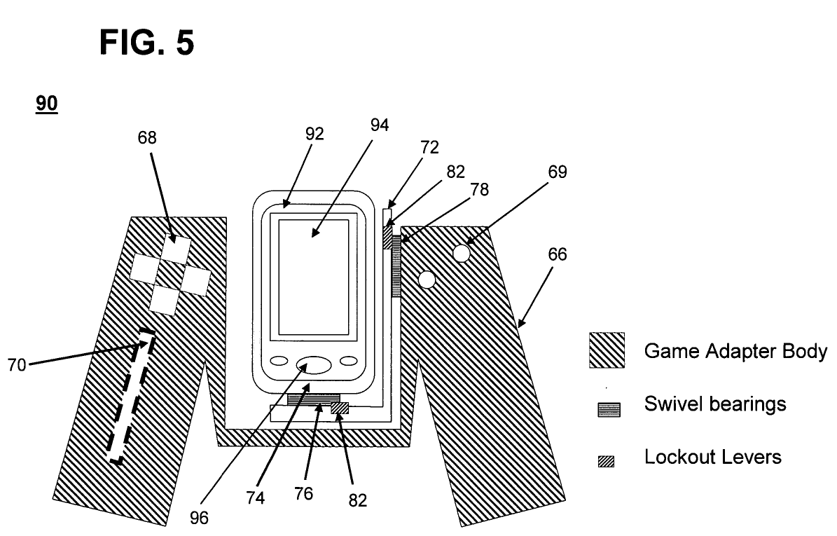

Referring to FIG. 4, an electronic controller apparatus 60 is shown similar to the electronic controller apparatus 30 of FIG. 3. In each instance, apparatus 30 and 60 includes a means for maintaining the display in the predetermined orientation using at least two swivel bearings at two pivot points enabling relative axial movement between the input device and the display in two separate orientations. In this example, an input device 66 is coupled to the electronic device 32 having the display 34. The input device 66 can include various inputs such as keypads 68 and 69 as well as motion sensor 70. The electronic controller apparatus 60 also includes a gravity based means for maintaining the display in a predetermined orientation relative to a user of the electronic device. The handheld electronic device 32 can be set in a cradle or bracket 74 that moves relative to another bracket 72. The bracket 72, in turn, can move relative to the input device 66. In this arrangement, the bracket 74 is coupled to the bracket 72 and moves relative to the bracket 72 using a swivel bearing 76. Likewise, the bracket 72 moves relative to the input device 66 using swivel bearing 78. The relative motion between brackets 72 and 74 and between the bracket 72 and the input device 66 can be fixed or locked using lockout levers 80 and 82 in a similar manner as described with respect to lockout levers 54 and 52 of FIG. 3. Now referring to FIG. 5, an electronic controller apparatus 90 is shown similar to the electronic controller apparatus 60 of FIG. 4, except that an electronic device 92 having a display 94 and controls or inputs 96 is used in conjunction with the input device 66. Electronic device 32 of FIG. 4 can be a cellular phone and device 92 of FIG. 5 can be a personal digital assistant. This merely illustrates that the input device can be configured to work with more than one type of electronic device. Note that electronic devices 32 and 92 might have different centers of gravity and may require some adjustment accordingly when used in conjunction with the input device 66. Also note that although the embodiments using gravity discussed above illustrate a dual pivot approach, other embodiments using any number of pivot points are contemplated within the scope of the present invention including embodiments having a single pivot point (e.g., an input device that allows left and right inputs only or climb and dive inputs only).

Referring to FIG. 6, a more complex means for maintaining the display in a predetermined orientation relative to a user of the electronic device is shown. Such an arrangement can allow for the use of tilt in unusual gaming positions, like use while lying on one's back. In addition, this more complex form would allow for a small proportional amount of tilting of the display with large tilting inputs should the user find that desirable. In this embodiment, an electronic controller apparatus 100 having an input device 101 can include a display 102 pivotably coupled to the input device 101 enabling relative movement in at least a first axis while maintaining the display in a first orientation. The display 102 can pivot on a ball 106 for example. The apparatus 100 can further include an electronic sensor such as a motion sensor or tilt sensor 105 within the input device 101 and optionally an electronic sensor such as motion sensor or tilt sensor 104 within the display 102. The display can maintain a first orientation using one or more electronic sensors and one or more motors 108 and 110. Note, the electronic controller apparatus 100 can be any number of electronic devices including a joystick having a built-in display.

The electronic controller apparatus 100 can use a controller or processor 112 to receive inputs from the electronic sensors and further provide output signals to drive the motors 108 and 110. The motor 108 can be driven to move the display 102 along a first axis or orientation while the motor 110 can be driven to move the display 102 along a second axis or orientation. Note, that the present invention is not limited in the number of orientations or motors used. The electronic sensors 104 and 105 can be MEMS accelerometers that can be used to drive small electric motors (108 and 110) to maintain the display in a given orientation.

Referring once again to FIG. 6, operationally, an apparatus 100 such as a joystick having a display and electronic sensors 104 and 105 can initially use sensor 104 to determine a desired orientation for the display. As the joystick or electronic apparatus 101 moves relative to the desired orientation, the sensors (104 and 105) can be used to drive the motors (108 and 110) to move the ball 106. In this manner, the display 102 pivots to remain substantially in the desired orientation set initially. The ball 106 can be smooth or alternatively dimpled or have some form of gears enabling rotation or pivoting at predetermined increments as the drive motors move or drive a surface frictionally coupled to the ball 106 in a particular orientation.

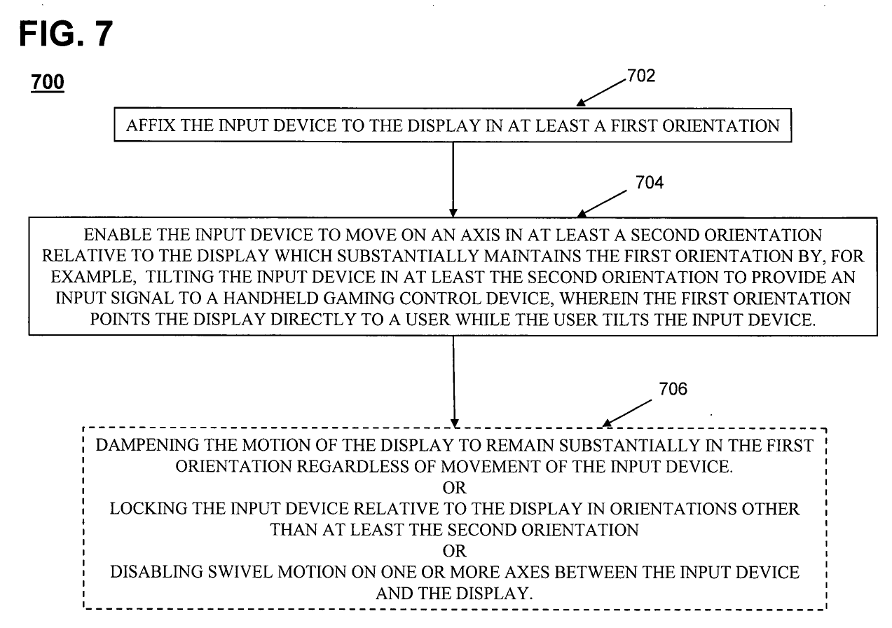

The sensor 104 can reside within the display to detect an orientation of the display or measure the display tilt which can be used to drive the motors to move the display so that the display remains level or in a given orientation. Referring to FIG. 7, a method 700 of orienting a display relative to an input device is shown. The method 700 can include the steps of affixing the input device to the display in at least a first orientation at step 702 and enabling the input device to move on an axis in at least a second orientation relative to the display which substantially maintains the first orientation at step 704. Step 704 can be done by tilting the input device in at least the second orientation to provide an input signal to a device such as a handheld gaming control device. In such an instance, the display forms a part of a handheld gaming control device and the first orientation points the display directly to a user of the handheld gaming control while the user tilts the input device. Optionally, the method 700 can include the step 706 of dampening the motion of the display to remain substantially in the first orientation regardless of movement of the input device or locking the input device relative to the display in orientations other than at least the second orientation or disabling swivel motion on one or more axes between the input device and the display.

Note that each of the embodiments above may need to transmit signals from their respective input devices to their respective displays. Although the means for sending information between input devices and a display on a game controller might present formidable challenges, particularly through articulated joints, several alternatives such as flexible multi-stranded wires, sliding contact rings with brushes, flexible printed circuits (“flex circuits”), and wireless transmission techniques (for example, using Bluetooth) can provide a robust and durable solution to overcome such challenges. Of course, a wireless transmission technique can likely eliminate many of the less than optimal mechanical and electrical interfaces in such an embodiment.

In light of the foregoing description of the invention, it should be recognized that the present invention can be realized in hardware or a combination of hardware and software. A method and system for controlled display orientation according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

Additionally, the description above is intended by way of example only and is not intended to limit the present invention in any way, except as set forth in the following claims.

1. A method of orienting a display relative to an input device, comprising the steps of:
affixing the input device to the display in at least a first orientation;
enabling the input device to move on an axis in at least a second orientation relative to the display which substantially maintains the first orientation.

2. The method of claim 1, wherein the method further comprises the step of dampening the motion of the display to remain substantially in the first orientation regardless of movement of the input device.

3. The method of claim 1, wherein the method further comprises the step of locking the input device relative to the display in orientations other than at least the second orientation.

4. The method of claim 1, wherein the method further comprises the step of disabling swivel motion on one or more axes between the input device and the display.

5. The method of claim 1, wherein the method further comprises the step of tilting the input device in at least the second orientation to provide an input signal to a handheld gaming control device, wherein the display forms a part of a handheld gaming control device and the first orientation points the display to a user of the handheld gaming control while the user tilts the input device.

6. An electronic controller apparatus having an input device coupled to a display, comprising:
a motion detector within the input device, wherein movement of the input device causes a signal to vary in the electronic controller apparatus; and
means for maintaining the display in a predetermined orientation relative to a user of the electronic device and regardless of the movement of the input device.

7. The electronic controller apparatus of claim 6, wherein the electronic controller apparatus is selected from the group comprising a game controller, a personal digital assistant, a cellular phone, a gaming adaptor for a personal digital assistant, a gaming adaptor for a cellular phone, and a remote control device.

8. The electronic controller apparatus of claim 6, wherein the electronic controller apparatus is a handheld device.

9. The electronic controller apparatus of claim 6, wherein the means for maintaining the display in the predetermined orientation uses gravity to maintain the predetermined orientation.

10. The electronic controller apparatus of claim 9, wherein the electronic apparatus further comprises a position adjustment device for fine tuning an orientation of the display using at least one among the group of center of gravity changers comprising a shiftable weight and a moving pivot.

11. The electronic controller apparatus of claim 6, wherein the means for maintaining the display in the predetermined orientation uses electronic sensors and motors to maintain the predetermined orientation.

12. The electronic controller apparatus of claim 11, wherein the electronic sensors comprise MEMS accelerometers within the display used to detect an orientation of the display and the motors are small electric motors driven by signals from the MEMs accelerometers.

13. The electronic controller apparatus of claim 6, wherein the electronic controller apparatus is a joystick.

14. The electronic controller apparatus of claim 6, wherein the means for maintaining the display in the predetermined orientation uses at least one swivel bearing at a pivot point between the input device and the display.

15. The electronic controller apparatus of claim 6, wherein the means for maintaining the display in the predetermined orientation uses at least two swivel bearings at two pivot points enabling relative axial movement between the input device and the display in two separate orientations.

16. An electronic controller having an input device, comprising:
a display pivotably coupled to the input device enabling relative movement in at least a first axis while maintaining the display in a first orientation; and
a tilt sensor within the input device.

17. The electronic controller apparatus of claim 16, wherein the display remains in the first orientation using gravity.

18. The electronic controller apparatus of claim 17, wherein the electronic apparatus further comprises a position adjustment device for fine tuning an orientation of the display using at least one among the group of center of gravity changers comprising a shiftable weight and a moving pivot.

19. The electronic controller apparatus of claim 16, wherein the display maintains the first orientation using electronic sensors and motors.

20. The electronic controller apparatus of claim 19, wherein the electronic sensors comprise MEMS accelerometers within the display used to detect an orientation of the display and the motors are small electric motors driven by signals from the MEMs accelerometers that serve to maintain the display in the first orientation.
